(19) United States
(12) Patent Application Publication
(10) Pub. No.: US 2008/0152823 A1
(43) Pub. Date: Jun. 26, 2008

(54) Self-limiting plating method

(75) Inventors: John Boyd, Hillsboro, OR (US); Yezdi Dordi, Palo Alto, CA (US); Tiruchirapalli Arunagiri, Fremont, CA (US); William Thie, Mountain View, CA (US); Fritz C. Redeker, Fremont, CA (US); Praveen Nalla, Fremont, CA (US)

Correspondence Address: CARR & FERRELL LLP, 2200 GENG ROAD, PALO ALTO, CA, 94303, US

(73) Assignee: Lam Research Corporation

(21) Appl. No.: 11/643,404

(22) Filed: Dec. 20, 2006

(51) Int. Cl. B05D 1/18

(52) U.S. Cl. 427/443.1

(57) ABSTRACT

A self-limiting electroless plating process is provided to plate thin films with improved uniformity. The process comprises dispensing an electroless plating solution onto a substrate to form a quiescent solution layer from which a conformal plated layer plates onto a surface of the substrate by a redox reaction. The redox reaction occurs at the surface of the substrate between a reducing agent ion and a plating ion and produces an oxidized ion. Because the solution is quiescent, a boundary layer forms within the solution layer adjacent to the surface. The boundary layer is characterized by a concentration gradient of the oxidized ion. Diffusion of the reducing agent ion through the boundary layer controls the redox reaction. The quiescent solution layer can be maintained until the reducing agent ion in the solution layer is substantially depleted.

### BACKGROUND OF THE INVENTION

1. Field of the Invention

The present invention relates generally to the field of semiconductor fabrication and more particularly to methods for electroless deposition.

2. Description of the Prior Art

Semiconductor device fabrication requires the creation of successive layers of patterned materials to form features that serve specific functions in the completed semiconductor devices. The layers are formed on a substrate, typically a silicon wafer, and the dimensions of the features in any particular layer need to be reproducible to a very high tolerance across the wafer. One type of layer provides conductive lines to carry signals laterally between various features within the completed semiconductor device. Metals, such as copper, are deposited over a dielectric layer that has been patterned to provide grooves for the copper lines. Another layer provides conductive vias to carry signals vertically between features. Again, metals such as copper are deposited in apertures that are defined within a dielectric layer.

One method for depositing copper is to plate the copper. With electroless plating, a solution containing copper ions is brought into contact with the substrate. The copper ions are reduced to metallic copper on a surface of the substrate through a reduction-oxidation (redox) reaction to form the plated layer. In order to bring fresh copper ions to the surface and to remove byproducts of the reaction, the solution is agitated or continuously refreshed. Continuously refreshing the copper plating solution allows the plating reaction to proceed rapidly and at a constant rate. In prior art plating methods, moreover, hydrogen gas is evolved at the surface and needs to be removed else the hydrogen can become deleteriously trapped in the plated layer. Agitating or refreshing the copper plating solution helps to remove the hydrogen.

More specifically, most conventional electroless plating solutions utilize formaldehyde-based reducing agents. In most cases these solutions incorporate some of the reducing agent into the deposited copper film, resulting in higher levels of organic contaminants in the film. Further, this type of chemistry is typically reused by recirculating the bulk solution and replenishing the reactants to maintain their concentrations.

With prior art electroless plating, however, achieving very thin and uniform plated layers can be difficult. To achieve a very thin plated layer requires stopping the redox reaction after only a short period of time. Thus, soon after the redox reaction begins, the electroless plating solution has to be removed from the substrate. If the electroless plating solution is removed from one location on the substrate before being removed from another, or if the redox reaction begins in one location before beginning in another, or both, the plated layer will vary in thickness.

Therefore, what is desired is a method for electroless plating that provides more uniformity to thin plated metal films.

### SUMMARY

An exemplary self-limiting electroless plating process of the present invention comprises forming a solution layer over a surface of a substrate, maintaining the solution layer in a quiescent state for a period of time to form a plated layer, and removing the solution layer from the substrate. Here, the solution layer comprises an electroless plating solution including a concentration of a plating ion, such as Cu⁺², and a concentration of a metal ion reducing agent, such as Co⁺². In various embodiments the metal ion reducing agent comprises a complexed metal ion reducing agent, or the plating ion comprises a complexed plating ion, or both. In some embodiments, maintaining the solution comprises forming a boundary layer adjacent to the surface of the substrate, where the boundary layer includes a concentration gradient of oxidized ions. In further embodiments, the oxidized ions are complexed oxidized ions.

In some instances, the process additionally comprises, before forming the solution layer, determining a quantity of electroless plating solution to dispense. Determining the quantity of electroless plating solution to dispense can depend on a concentration of the metal ion reducing agent in the electroless plating solution, in some embodiments.

Another exemplary self-limiting electroless plating process of the present invention comprises dispensing a quantity of an electroless plating solution onto a substrate to form a quiescent solution layer, and forming a plated layer by a redox reaction. Here, the quantity of the electroless plating solution includes a concentration of a reducing agent ion and an excess concentration of a plating ion and the redox reaction is between the reducing agent ion and the plating ion. Also, forming the plated layer includes forming a boundary layer within the solution layer adjacent to the substrate, and diffusing the reducing agent ion through the boundary layer. The boundary layer, in this embodiment, includes a concentration gradient of an oxidized ion formed by the redox reaction. The boundary layer can have a thickness in the range of about 5 Å to 100 Å, for example. Forming the plated layer can further include maintaining the quiescent solution layer until the reducing agent ion in the solution layer is substantially depleted. In various embodiments, the reducing agent ion comprises a metal ion or a complexed metal ion. The complexed metal ion can include, in some instances, a diamine, triamine, or polyamine.

The present invention also provides a semiconductor device including a plated layer. In these embodiments, the plated layer is fabricated by a self-limiting electroless plating process. In some embodiments, the plated layer has a thickness in the range of 20 Å to 2000 Å. In some of these embodiments, a uniformity of the thickness is within 10%.

### BRIEF DESCRIPTION OF DRAWINGS

FIG. 1A illustrates an electroless plating solution on a surface of a substrate at the initiation of electroless plating, according to an exemplary embodiment of the invention.

FIG. 1B is an enlarged view of an interface between the substrate and the electroless plating solution of FIG. 1A.

FIG. 2 illustrates the evolution of the chemistry of the electroless plating solution of FIG. 1 as electroless plating continues, according to an exemplary embodiment of the invention.

FIG. 3 illustrates a plated layer formed on the surface of the substrate of FIG. 1, and the final chemistry of the electroless plating solution at the conclusion of electroless plating, according to an exemplary embodiment of the invention.

FIG. 4 is an enlarged view of a portion of the interface between the electroless plating solution and the surface of the substrate of FIG. 2.

FIG. 5 is a graph illustrating the dependence of the plated layer thickness on the plating time as a function of the chemistry of the electroless plating solution, according to an exemplary embodiment of the invention.

FIG. 6 is a graph illustrating the self-limiting nature of the electroless plating, according to an exemplary embodiment of the invention.

FIG. 7 is a flow-chart representation of an exemplary electroless plating method, according to an embodiment of the invention.

### DETAILED DESCRIPTION OF THE INVENTION

The present invention provides methods for electroless plating of metals, such as copper, during semiconductor device fabrication. These methods involve a redox reaction between two species of ions in an electroless plating solution where one ion species gives up electrons to the other ion species. The ion species that accepts the electrons is plated from the electroless plating solution to produce a conformal plated layer on a surface. Advantageously, the methods provided herein are self-limiting. Specifically, in any given area, the plated layer will develop to essentially the same thickness so that the resulting plated layer has a uniform thickness. Thickness uniformity can be achieved even if plating is non-uniformly initiated across the substrate. The final thickness of the plated layer can be controlled by controlling the concentrations of the ion species in the electroless plating solution and the amount of the solution that is used. A further advantage of the methods described herein is that the consumption of electroless plating solution is reduced.

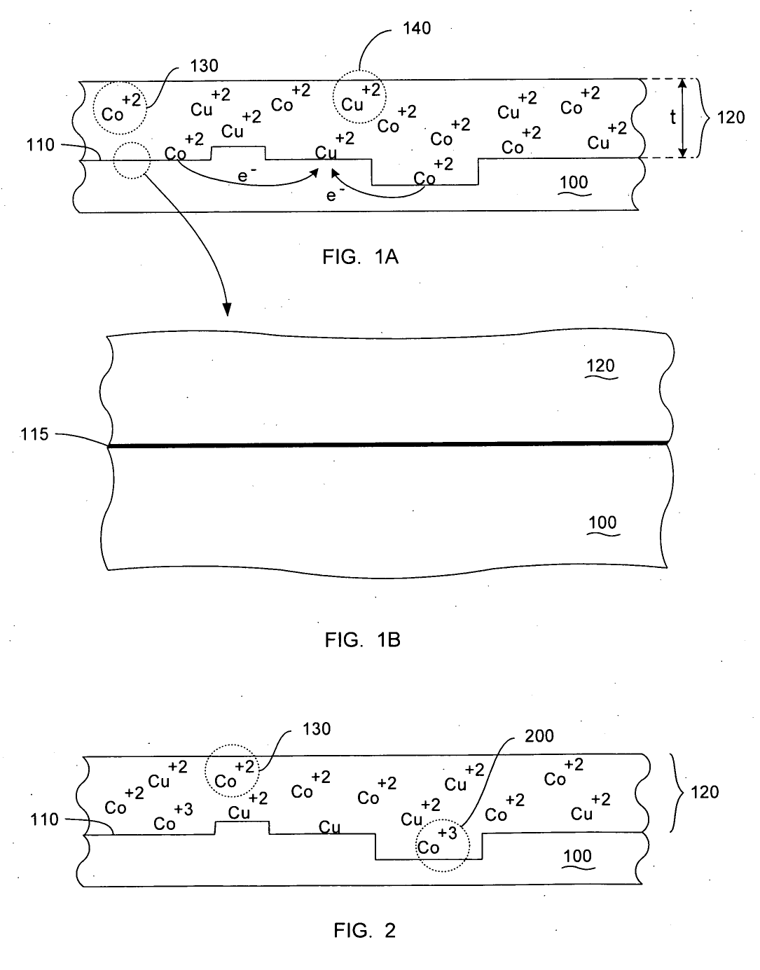

FIG. 1A illustrates a dielectric substrate 100 having a surface 110 in contact with an electroless plating solution at the initiation of an electroless plating process, according to an exemplary embodiment of the invention. FIG. 1B shows an enlarged view of a circled portion of FIG. 1A. The substrate 100 can comprise, for instance, a dielectric material such as an organosilicate glass (OSG). The substrate 100 need not be flat and can have a topography including trenches and raised features, as illustrated. The trenches can comprise a lithographically defined pattern intended to be filled with a metal to form a set of conductive lines, for example. As another example, the trenches can be high aspect ratio openings for forming conductive vias.

In the methods of the present invention, the electroless plating is auto-catalytic, meaning that the surface 110 catalyzes the redox reaction by conducting electrons (e⁻) from the reducing agent ions 130 to the plating ions 140. Since the substrate 100 comprises a dielectric material, a conductive coating 115 (FIG. 1B) can be applied to the substrate 100, for example, by Physical Vapor Deposition (PVD) or Atomic Layer Deposition (ALD). An example of a suitable material for the conductive coating is tantalum. The conductive coating 115 can be as thin as an atomic monolayer, in some embodiments. It will be appreciated, therefore, that although FIG. 1A shows electrons passing through the bulk of the substrate 100 for illustrative purposes, in actuality the electron conduction is through the conductive coating 115 (FIG. 1B). If less than the entire surface 110 is to be plated, specific areas to be plated can be defined on the surface 110, for example, by patterning the conductive coating 115.

At the start of the electroless deposition, a solution layer 120 is formed above the substrate 100. The solution layer 120 has a thickness, t, and initially includes a reducing agent ion 130, such as a metal ion, that can donate electrons and a plating ion 140 that can accept electrons in order to plate a metal onto the conductive coating 115. It will be understood that the topography variations of the substrate 100 are exaggerated in FIG. 1A relative to the thickness, t, of the solution layer 120 for illustrative purposes. In the example of FIG. 1A, the reducing agent ion 130 is Co⁺² and the plating ion 140 is Cu⁺², though other ionic species can be used for either. As discussed further herein, in some embodiments one or both of the ions 130, 140 are complexed ions.

As noted, the conductive coating 115 catalyzes the redox reaction between the reducing agent ion 130 and the plating ion 140. In FIG. 1A, this is illustrated by Co⁺² and Cu⁺² ions in contact with the surface 110. Those ions in contact with the conductive coating 115 participate in the redox reaction. In the particular example shown in FIGS. 1A and 2 the plating ion 140, Cu⁺², is reduced to metallic copper (Cu), and each ion of the reducing agent ion 130, Co⁺², is oxidized to Co⁺³. Thus, each ion of the plating ion 140 that is in contact with the conductive coating 115 accepts two electrons from each of two ions of the reducing agent ion 130 also in contact with the conductive coating 115.

In other embodiments of the invention, the ratio of the plating ion 140 to the reducing agent ion 130 in the redox reaction can be different than the 1:2 ratio of the given example. It will be appreciated, however, that it is advantageous to have more than one ion of the reducing agent ion 130 donate an electron to an ion of the plating ion 140 to lessen the rate of the redox reaction within the bulk of the solution layer 120, as compared to the auto-catalytic reaction. For the redox reaction to occur between Co⁺² and Cu⁺² ions within the bulk of the solution layer 120, two Co⁺² ions collide with one Cu⁺² ion either simultaneously or consecutively. Due to the numbers of ions in the solution layer 120, the redox reaction occurs in the bulk of the solution layer 120 at some finite rate. However, the rate is lower than that of the surface reaction, in part, because electron transfer via a catalytic surface is more efficient than transfer via bulk solution. A 3:1 ratio, for example, would lessen the rate of the redox reaction within the bulk solution layer 120 further still, as the concentration of reducing agent ions relative to the plating ion would be reduced. On the other hand, regardless of the ratio of reducing agent ions to plating ions, at any given time a substantial number of ions of both ions 130, 140 are in contact with the conductive coating 115, allowing the redox reaction to readily proceed at the surface 110.

As further shown by FIG. 2, as the reducing agent ion 130 is oxidized, an oxidized ion species 200 begins to form at the surface 110. In the present example, the oxidized ion 200 comprises Co⁺³. In embodiments where the reducing agent ions 130 are complexed, the resulting oxidized ions 200 can also be complexed. Suitable complexing agents for the example of FIGS. 1A-3 include organic compounds of diamine, triamine and polyamine. Specific examples of suitable electroless plating solutions can be found in U.S. non-provisional patent application Ser. No. 11/382,906 filed on May 11, 2006 and U.S. non-provisional patent application Ser. No. 11/427,266 filed Jun. 28, 2006, both titled “Plating Solutions for Electroless Deposition of Copper” and both incorporated herein by reference.

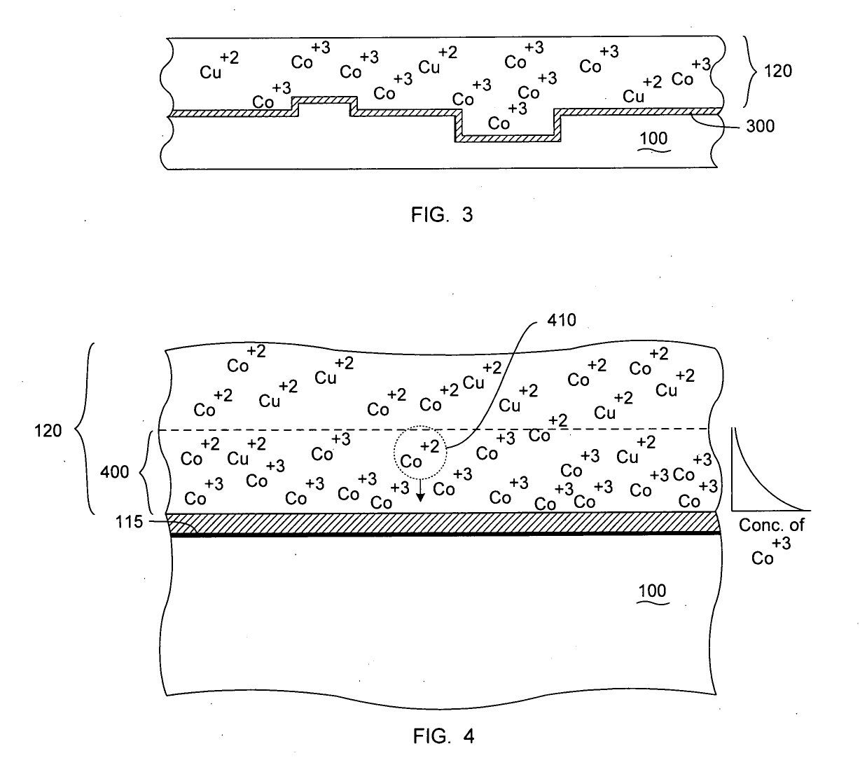

As shown in FIG. 3, the reduction of the plating ion 140 produces a conformal plated layer 300. The plated layer 300 continues to thicken so long as a supply of both reducing agent ions 130 and plating ions 140 remain in the solution layer 120. The redox reaction can therefore be controlled, for instance, by controlling the concentrations of the reducing agent ion 130 and of the plating ion 140 in the solution layer 120. In particular, where there is an excess of the reducing agent ion 130, electroless plating slows as the concentration of the plating ion 140 becomes depleted. Where there is an excess of the plating ion 140, on the other hand, electroless plating slows as the concentration of the reducing agent ion 130 becomes depleted. This latter situation is illustrated in FIG. 3 where ions of the plating ion 140 (Cu⁺²) remain in the solution layer 120 after the ions of the reducing agent ion 130 (Co⁺²) have been depleted.

As noted with respect to FIGS. 2 and 3, the ions of the reducing agent ion 130 are oxidized to the oxidized ion 200 at the conductive coating 115. After oxidation, the oxidized ions 200 begin to diffuse into the solution layer 120. As shown in FIG. 4, an enlarged view of a portion of FIG. 2, if the solution layer 120 is quiescent, that is, not flowing across the surface 110 and not being mixed, stirred, or otherwise agitated, then a boundary layer 400 of oxidized ions 200 will form within the solution layer 120 adjacent to the substrate 100 and over the growing plated layer 300. The thickness of the boundary layer 400, and the concentration of the oxidized ion 200 within the boundary layer 400, will increase with time as more of the reducing agent ion 130 is consumed. A well developed boundary layer 400 can have a thickness in the range of about 5 Å to 100 Å, in some embodiments. As illustrated by the graph alongside the boundary layer 400 in FIG. 4, the boundary layer 400 is characterized by a concentration gradient of the oxidized ions 200 that decreases with distance from the surface 110.

The boundary layer 400 inhibits diffusion of the reducing agent ion 130 towards the surface 110. In FIG. 4 a reducing agent ion 410 is shown diffusing across the boundary layer 400. The rate at which the reducing agent ions 130 are able to reach the conductive coating 115, and later the plated layer 300, becomes diffusion limited as the boundary layer 400 develops. It will be understood that in those embodiments where the reducing agent ions 130 are complexed, the reducing agent ions 130 will diffuse even more slowly across the boundary layer 400 due to the larger size of the complexed ions. Also, in those embodiments where the oxidized ions 200 are complexed, these ions will diffuse more slowly into the solution layer 120 and will form a boundary layer 400 that will be even more resistive to the diffusion of the reducing agent ions 130 towards the surface 110.

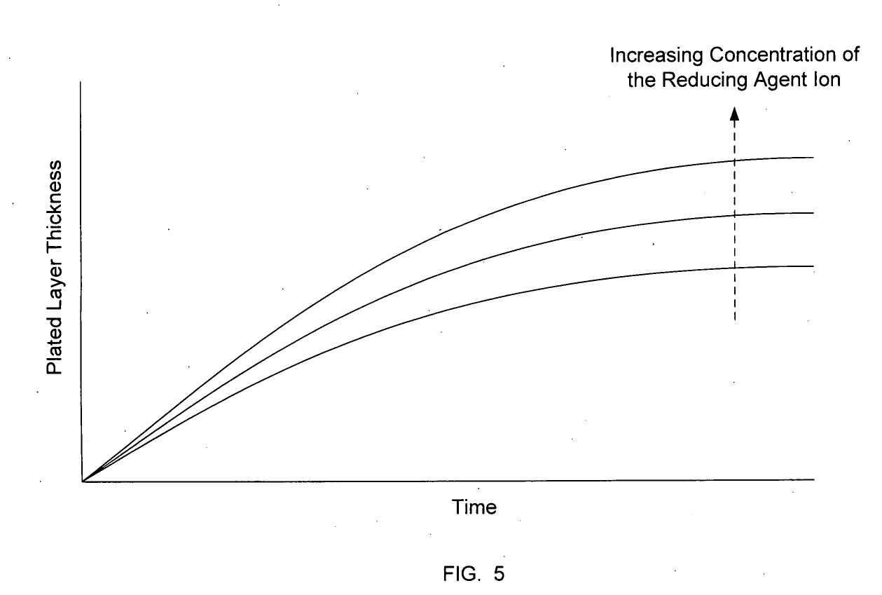

FIG. 5 illustrates the time dependence of the thickness of the plated layer 300 on the concentration of the reducing agent ion 130 in the solution layer 120 where both the solution layer 120 is quiescent and the solution layer 120 comprises an excess of the plating ion 140. It can be seen that the final thickness of the plated layer 300 increases as the concentration of the reducing agent ion 130 in the initial solution layer 120 increases. Also, the rate of growth of the plated layer 300 is essentially constant at the beginning of the electroless plating process, but as the reducing agent ion 130 becomes oxidized, the rate of growth slows as the boundary layer of by-products increases, inhibiting access of fresh reactants to the catalytic surface. The thickness of the plated layer 300 ultimately approaches a final thickness, in an asymptotic manner, as the reducing agent ion 130 is depleted from the solution layer 120 and saturates the catalytic surface and boundary layer with the oxidized or complexed by-product.

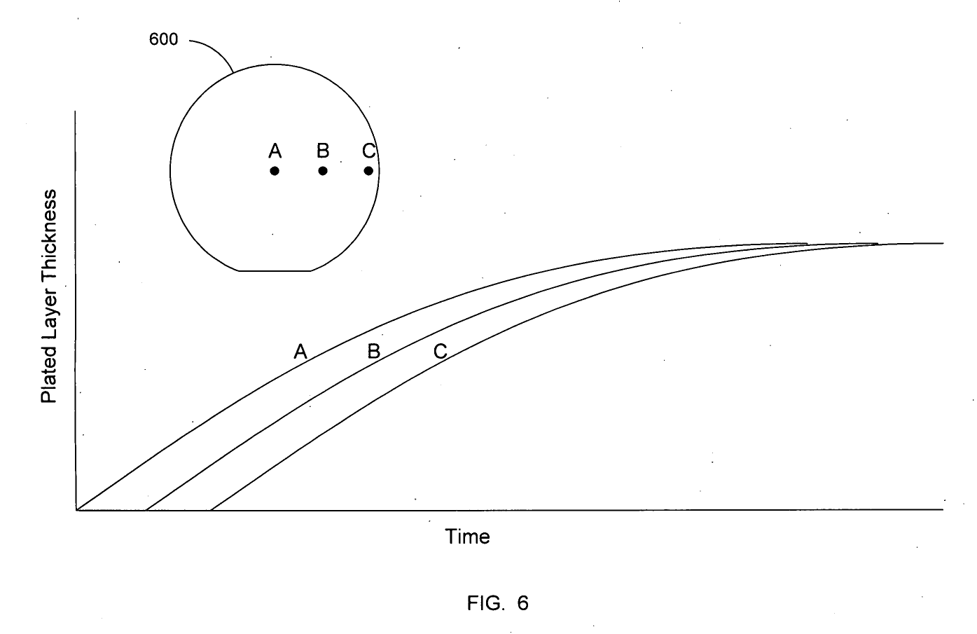

The self-limiting nature of the methods of the invention allows the final thickness of the plated layer 300 to be relatively insensitive to differences in when the redox reaction is initiated on different parts of the substrate 100. Such differences can be due, for example, to an incubation period that can occur prior to the initiation of the redox reaction, and this incubation period can have a radial or areal dependence, in some instances. FIG. 6 illustrates this advantage where the redox reaction initiates at different times at different locations on a surface of a substrate. In FIG. 6, a semiconductor wafer 600 includes three points, a point A at the center of the wafer 600, a point C near an edge of the wafer 600, and a point B halfway between points A and C. Assuming an incubation period with a radial dependence that increases from the center point A to the edge point C the redox reaction will begin later at point B than at point A, and later still at point C.

Also shown in FIG. 6 is a graph of the thickness of the plated layer 300 as a function of time for each of the three points A-C. Even though the start of the redox reaction is delayed at points further from the center point A, the redox reaction ultimately produces the same thickness of the plated layer 300 at each of the points A-C. This occurs because, although reducing agent ions are being depleted and the catalytic surface and proximate boundary layer is being passivated by the reaction by-products sooner at point A than point B, for example, in the quiescent solution layer there is little mixing to remove reaction by-products and facilitate steady-state growth across the wafer 600. It will be appreciated, therefore, that thickness uniformity of the plated layer 300 according to the present invention does not require that the redox reaction occur across the wafer 600 at a uniform rate and at the same time. Here, thickness uniformity is achieved by waiting until the redox reaction saturates the catalytic surface and boundary layer with reaction by-products, or depletes the available reducing agent ion in all locations.

Another advantage of the methods described herein, as noted previously, is that the methods provide for decreased electroless plating solution consumption. Under prior art methods of electroless plating of thin plated layers, large volumes of electroless plating solution are used and only a small fraction of the available plating ion is consumed before the electroless plating solution is removed to stop the redox reaction. In the present invention, on the other hand, a much larger proportion of the available plating ions 140 are consumed before the reducing agent ions 130 in the solution layer 120 are depleted. Accordingly, consumption of the electroless plating solution is significantly reduced.

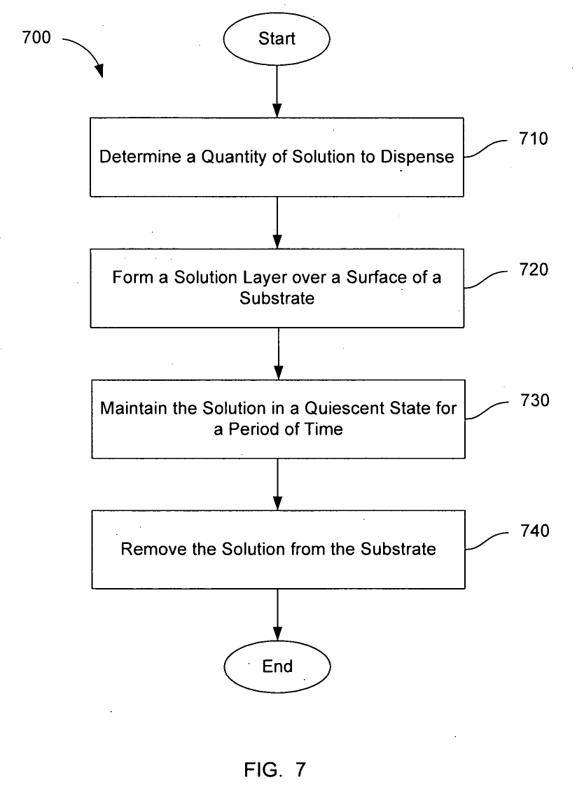

FIG. 7 provides a flow-chart representation of an exemplary electroless plating process 700 of the invention, including determining a quantity of electroless plating solution to dispense, in accordance with the above description. The process 700 comprises determining 710 a quantity of electroless plating solution to dispense, forming 720 a solution layer over a surface of a substrate, maintaining 730 the solution layer in a quiescent state for a period of time, and removing 740 the solution layer from the substrate. In this embodiment, the entire surface of the substrate, or selected portions of the surface, are made electrically conductive with a conductive coating. Additionally, the reducing agent ion comprises a metal ion that is complexed, in some embodiments.

In order to achieve a desired thickness for the plated layer, a quantity of electroless plating solution can be initially determined 710. Here, the concentrations of the plating ion and the reducing agent ion in the electroless plating solution are both known, and the concentration of the plating ion is sufficiently high so that in a subsequent redox reaction the reducing agent ion will be substantially deplete before the plating ion is depleted. For the example of FIGS. 1-4, an excess of the plating ion 140 requires that the concentration of the reducing agent ion 130 be less than twice the concentration of the plating ion 140 in the electroless plating solution.

One way to determine 710 the appropriate quantity of the electroless plating solution is to first perform a calibration to create a calibration curve. Performing the calibration can include plating test wafers with varying amounts of the electroless plating solution. The resulting plated layers from the several calibration tests can be analyzed to determine their thicknesses. The analyses of the plated layers will yield a calibration curve of plated layer thickness as a function of the quantity of the electroless plating solution. The appropriate quantity of electroless plating solution can be read from the calibration curve for any desired thickness in a calibrated range.

Another method for determining 710 the appropriate quantity of the electroless plating solution comprises calculating the quantity. In practice, the surface area (mm²) to be plated, the concentration (g/ml) of the reducing agent ion in the electroless plating solution, the chemistry of the redox reaction, the atomic or molecular weights (g/mole) of the ions involved in the redox reaction, and the density (g/mm³) of the plated layer are each well known values. Therefore, for a desired thickness of the plated layer, a volume of solution that needs to be dispensed onto the substrate to achieve the desired thickness of the plated layer may be readily calculated.

For the example of FIGS. 1-4, an appropriate quantity of electroless plating solution can be calculated as follows. The desired thickness (nm) of the plated layer multiplied by the density (g/nm-mm²) of the plated layer 300 yields the mass per unit area (g/mm²) that will be plated onto the surface 110. This value, multiplied by the surface area (mm²) to be plated yields the total mass (g) to be plated. The total mass, divided by the atomic weight (g/mole) of the ions of the plating ion 140 provides a total number (moles) of plating ions 140 that will be plated.

In the example of FIGS. 1-4, since two reducing agent ions 130 are consumed for every plating ion 140 that is reduced and plated, twice as many reducing agent ions 130 have to be available within the quantity of electroless plating solution. The number (moles) of reducing agent ions 130 in the quantity of electroless plating solution multiplied by the atomic weight (g/mole) of the reducing agent ion 130 will yield the total mass (g) of reducing agent ion 130 in the required quantity of electroless plating solution. The total mass (g) of reducing agent ion 130 divided by the concentration (g/ml) of the reducing agent ion 130 in the electroless plating solution provides the volume (ml) of the electroless plating solution that needs to be dispensed to form the solution layer 120.

In the above calculation, where complexed ions are used, appropriate molecular weights are substituted for atomic weights. It will be understood that the above calculation assumes complete depletion of the reducing agent ion 130, which may not be a practical endpoint. However, the above calculation can be readily modified to account for substantial, rather than complete, depletion. The above calculation can be readily modified also to account for point-of-use mixing to calculate the separate quantities of the two precursor solutions to be mixed. Also, the above calculation can serve as a basis for establishing a range of quantities of the electroless plating solution to use to generate a calibration curve.

As noted previously, one advantage of the method 700 is that it is conservative with respect to electroless plating solution consumption. For a 300 mm diameter substrate, an exemplary quantity of electroless plating solution is less than 400 ml. An exemplary quantity of electroless plating solution is about 200 ml or less for a 200 mm diameter substrate.

Forming 720 the solution layer over the surface of the substrate can be achieved in a number of ways, depending on the deposition tool being used. Thickness uniformity of the plated layer will generally be independent of the method by which the solution layer is formed, so long as the solution layer rapidly settles into a quiescent state. A goal of forming 720 the solution layer, therefore, is to form the solution layer quickly and in such a manner that the solution layer rapidly achieves quiescence.

One method for forming 720 the solution layer comprises introducing the electroless plating solution through a nozzle positioned over a center of the substrate. In contrast to many conventional coating processes where a solution is dispensed over the center of a substrate, in some embodiments of the present invention the substrate is not spun while forming 720 the solution layer. Not spinning the substrate serves to lessen turbulence in the solution layer so that quiescence is achieved more rapidly.

Another method for forming 720 the solution layer comprises dispensing the electroless plating solution from a plurality of injection ports evenly spaced around a circumference of the substrate, or evenly spaced across the substrate. Using multiple injection ports allows the electroless plating solution to be dispensed more rapidly. In some embodiments, dispensing the electroless plating solution through the plurality of injection ports is achieved in a few seconds. The injection ports can be aimed at the center of the substrate, for example, to avoid creating rotational flow within the solution layer.

After the solution layer has been formed 720, the solution layer is maintained 730 in a quiescent state for a period of time sufficient to form a plated layer with the desired thickness on the substrate. In some embodiments, a sufficient period of time is in the range of about 30 seconds to 3 minutes. The plated layer that is formed while the solution layer is maintained 730 in the quiescent state can be conformal to the topography of the substrate, including the sidewalls of high aspect ratio features such as vias. The thickness of the plated layer can be in the range of 20 Å to 2000 Å, in some embodiments. An exemplary uniformity, for a plated layer with a nominal thickness of 50 Å is ±5 Å. A further advantage of the methods of the present invention is that they result in higher purity plated films characterized by much lower levels of organic contamination as compared to films plated with formaldehyde-based reducing agents.

After the solution layer has been maintained 730 in the quiescent state to form the plated layer, the solution layer is removed 740 from the substrate. Removing 740 the solution layer can be achieved, for example, by a quench, followed by a rinse and drying. The quench can be a fast flush of sprayed deionized (DI) water, for instance, to substantially remove the solution layer. The further rinse can be performed to more completely clean the surface.

The electroplating processes described above preferably will take place in a chamber which is part of a larger controlled ambient system that is substantially void of oxygen and other undesired elements. By providing an integrated cluster architecture, which defines and controls the ambient conditions between and, in disparate chambers or processing systems, it is possible to fabricate different layers, features, or structures immediately after other processing operations in the same overall system, while preventing the substrate from coming into contact with an uncontrolled environment (e.g., having more oxygen or other undesired elements than may be desired). Descriptions of exemplary systems are providing in U.S. application Ser. No. 11/514,038, filed on Aug. 30, 2006, and entitled “Processes and Systems for Engineering a Barrier Surface for Copper Deposition,” U.S. application Ser. No. 11/513,634, filed on Aug. 30, 2006, and entitled “Processes and Systems for Engineering a Copper Surface for Selective Metal Deposition,” and U.S. application Ser. No. 11/461,415, filed on Jul. 27, 2006, and entitled “System and Method for Forming Patterned Copper lines Through Electroless Copper Plating,” all of which are hereby incorporated by reference.

Other exemplary systems and processes for performing plating operations are described in more detail in: U.S. Pat. No. 6,864,181, issued on Mar. 8, 2005; U.S. patent application Ser. No. 11/014,527, filed on Dec. 15, 2004 and entitled “Wafer Support Apparatus for Electroplating Process and Method For Using the Same;” U.S. patent application Ser. No. 10/879,263, filed on Jun. 28, 2004 and entitled “Method and Apparatus for Plating Semiconductor Wafers;” U.S. patent application Ser. No. 10/879,396, filed on Jun. 28, 2004 and entitled “Electroplating Head and Method for Operating the Same;” U.S. patent application Ser. No. 10/882,712, filed on Jun. 30, 2004 and entitled “Apparatus and Method for Plating Semiconductor Wafers;” and U.S. patent application Ser. No. 11/205,532, filed on Aug. 16, 2005 and entitled “Reducing Mechanical Resonance and Improved Distribution of Fluids in Small Volume Processing of Semiconductor Materials,” all of which are hereby incorporated by reference.

In the foregoing specification, the invention is described with reference to specific embodiments thereof, but those skilled in the art will recognize that the invention is not limited thereto. Various features and aspects of the above-described invention may be used individually or jointly. Further, the invention can be utilized in any number of environments and applications beyond those described herein without departing from the broader spirit and scope of the specification. The specification and drawings are, accordingly, to be regarded as illustrative rather than restrictive.

What is claimed is:

1. A self-limiting electroless plating process comprising:
forming a solution layer over a surface of a substrate, the solution layer comprising an electroless plating solution including a concentration of a plating ion and a concentration of a metal ion reducing agent;
maintaining the solution layer in a quiescent state for a period of time to form a plated layer; and
removing the solution layer from the substrate.

2. The electroless plating process of claim 1 wherein forming the solution layer includes dispensing the electroless plating solution over a center of the substrate without spinning the substrate.

3. The electroless plating process of claim 1 wherein forming the solution layer includes dispensing the electroless plating solution from a plurality of injection ports evenly spaced around a circumference of the substrate.

4. The electroless plating process of claim 1 wherein forming the solution layer includes dispensing the electroless plating solution from a plurality of injection ports evenly spaced across the substrate.

5. The electroless plating process of claim 1 wherein the metal ion reducing agent comprises a complexed metal ion reducing agent.

6. The electroless plating process of claim 5 wherein the complexed metal ion reducing agent comprises Co⁺².

7. The electroless plating process of claim 1 wherein the plating ion comprises a complexed metal plating ion.

8. The electroless plating process of claim 7 wherein the complexed plating ion comprises Cu⁺².

9. The electroless plating process of claim 1 wherein maintaining the solution comprises forming a boundary layer adjacent to the surface of the substrate, the boundary layer including a concentration gradient of oxidized ions.

10. The electroless plating process of claim 9 wherein the oxidized ions are complexed oxidized ions.

11. The electroless plating process of claim 1 further comprising, before forming the solution layer, determining a quantity of electroless plating solution to dispense.

12. The electroless plating process of claim 11 wherein determining the quantity of electroless plating solution to dispense depends on a concentration of the metal ion reducing agent in the electroless plating solution.

13. A self-limiting electroless plating process comprising:
dispensing a quantity of an electroless plating solution onto a substrate to form a quiescent solution layer, the quantity of the electroless plating solution including a concentration of a reducing agent ion and an excess concentration of a plating ion; and
forming a plated layer by a redox reaction between the reducing agent ion and the plating ion, including
forming a boundary layer within the solution layer adjacent to the substrate, the boundary layer including a concentration gradient of an oxidized ion formed by the redox reaction; and
diffusing the reducing agent ion through the boundary layer.

14. The process of claim 13 wherein the reducing agent ion comprises a metal ion.

15. The process of claim 13 wherein the reducing agent ion comprises a complexed metal ion.

16. The process of claim 15 wherein the complexed metal ion includes a diamine, triamine, or polyamine.

17. The process of claim 13 wherein the boundary layer has a thickness in the range of about 5 Å to 100 Å.

18. The process of claim 13 wherein forming the plated layer further includes maintaining the quiescent solution layer until the reducing agent ion in the solution layer is substantially depleted.

19. The process of claim 13 further comprising determining the quantity of the electroless plating solution before dispensing the electroless plating solution.

20. The process of claim 13 further comprising removing the solution layer from the substrate.

21. The process of claim 20 wherein removing the solution layer from the substrate includes a quench followed by a rinse and a drying.

22. A semiconductor device including a plated layer fabricated by a self-limiting electroless plating process comprising:
forming a solution layer over a surface of a substrate, the solution layer comprising an electroless plating solution including a concentration of a plating ion and a concentration of a metal ion reducing agent;
maintaining the solution layer in a quiescent state for a period of time to form the plated layer; and
removing the solution layer from the substrate.

23. The semiconductor device of claim 22 wherein the plated layer has a thickness in the range of 20 Å to 2000 Å.

24. The semiconductor device of claim 23 wherein a uniformity of the thickness is within 10%.
